(19) United States
(12) Patent Application Publication
(10) Pub. No.: US 2017/0212561 A1
(43) Pub. Date: Jul. 27, 2017

(54) POWER SUPPLY UNIT FAN MANAGEMENT

(71) Applicant: Quanta Computer Inc., Taoyuan City (TW)

(72) Inventors: Kai-Fan KU, Taoyuan City (TW); Chin-Fu TSAI, Taoyuan City (TW); Yung-Fu LI, Taoyuan City (TW)

(21) Appl. No.: 15/007,737

(22) Filed: Jan. 27, 2016

(51) Int. Cl. G06F 1/20; G06F 1/18; G06F 1/32

(52) U.S. Cl. CPC G06F 1/206; G06F 1/3253; G06F 1/3209; G06F 1/189

(57) ABSTRACT

In some implementations, a system controller of a computing device can be configured to obtain power supply unit (PSU) fan airflow direction information. The system controller is configured to retrieve t a pre-defined airflow direction of PSU fan, and to determine whether the current airflow direction of PSU fan is consistent with the retrieved pre-defined fan airflow direction. In some implementations, upon determining that the current airflow direction of PSU fan is inconsistent with the pre-defined fan airflow direction, the system controller can cause an indication device associated with the PSU to be toggled. The indication device indicates that the PSU fan has been incorrectly installed and notifies the technician that over-temperature fault can occur due to incorrect installment.

### TECHNICAL FIELD

The disclosure generally relates to power supply unit (PSU) fan management, and more specifically to detecting and managing data related to power unit fan airflow direction.

### BACKGROUND

A server often includes a power supply unit (PSU) for supplying power to the server. For heat dissipation caused by the PSU operation, the PSU includes a PSU fan. For example, the PSU fan can be installed in at least two directions: the fan facing the center of the server (forward) or the fan facing one end of the server (backward). If the PSU fan is not installed properly, it will affect cooling efficiency of the server.

However, there may be difficulty figuring out whether the PSU fan is correctly installed, because the recommended airflow direction of the PSU fan may not be marked on the outside of the PSU fan or the PSU. Accordingly, the assembly-technician may not know the correct/recommended direction for the PSU fan installment at the time of installation and install the fan incorrectly. Further, even though such improper installation may result in overheating, overheating is usually not easy to detect until after the PSU has been operating for a certain amount of time.

### SUMMARY

In some implementations, a system controller of a computing device can be configured to obtain information on the current airflow direction of a power supply unit (PSU) fan. The system controller is configured to retrieve the pre-defined (correct/recommended) PSU fan direction, and to determine whether the current PSU airflow fan direction is consistent with the pre-defined PSU fan direction. In some implementations, upon determining that the current PSU airflow fan direction is not consistent with the pre-defined (recommended/correct) fan direction, the system controller can cause an indicator device associated with the PSU to be activated to indicate that the PSU fan needs to be re-installed.

In some examples, the current PSU fan direction can be compared with a current server fan direction. The system controller is further configured to compare the current PSU airflow fan direction with the current server fan direction, and determine if the server fan direction is consistent with the PSU fan direction. Upon determining that the server fan direction is inconsistent with the PSU fan direction, the indicator device is activated to indicate that the PSU fan direction needs to be corrected.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates a block diagram of an example system for a power supply unit (PSU) fan management.

FIG. 2 is an example system when an indication device is active.

FIG. 3 is an example system when an indication device is inactivate.

FIGS. 4A and 4B are flow diagrams of an example process for managing a power supply unit fan.

FIG. 5 is a block diagram of an example system architecture implementing the features and processes of FIGS. 1-4.

Like reference symbols in the various drawings indicate like elements.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

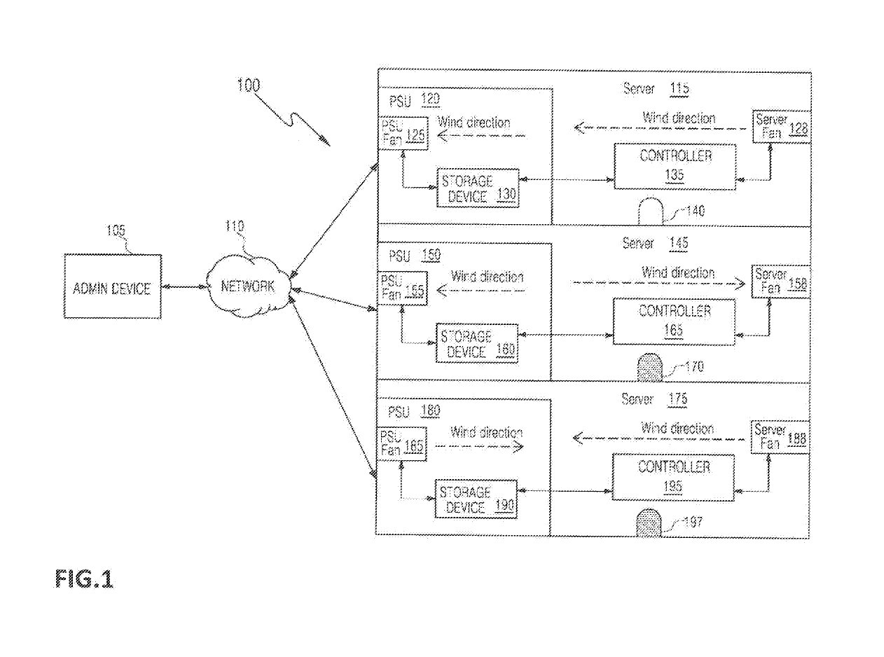

FIG. 1 illustrates an example rack system 100 configured for managing power supply unit (PSU) fans in accordance with the various embodiments. As shown in FIG. 1, the rack system includes servers 115, 145, and 175 with respective server fans 128, 158, and 188. Further, each of servers 115, 145, and 175 includes respective controllers 135, 165, and 195, respective PSUs 120, 150, and 180, and respective indicator devices 140, 170, and 197. The controllers 135, 165, and 195 can be communicatively coupled to respective ones of PSU 120, 150, and 180, respective ones of server fans 128, 158, and 188, and respective ones of indicator device 140, 170, and 197.

The servers 115, 145, and 175 may be coupled to a network 110 via controllers 135, 165, and 195. An administrator, or other user, can use a server administration application on administrative device 105 (e.g., a laptop computer, handheld device, etc.) to send a command through network 110 (e.g., local area network, wide area network, wireless network, Internet, etc.) to the dedicated network interface controller of system controllers 135. 165, and 195.

Each of PSUs 120, 150, and 180 can include respective PSU fans 125, 155, and 185 communicatively coupled to respective storage devices 130, 160, and 190. The controllers 135, 165, and 195 can be communicatively coupled to PSUs 120, 150, and 180 via the storage devices 130, 160, and 190, respectively.

Controllers (e.g., system controller, management controller) 135, 165, 195 can be service processors (e.g., a baseboard management processor) that provide independent operating system and/or pre-operating system management of server 115, 145, 175. For example, baseboard management controller (BMC) is processor configured to provide out-of-band management/administration of servers and other computing devices. The system controller can operate independently of the central processing unit and/or operating system of a computing device.

Controllers (e.g. baseboard management controller) 135, 165, 195 can be configured with an operating system and/or other computer-readable instructions for performing remote control of the power supply units, 120, 150, 180 as described herein. For example, management controllers 135, 165, 195 can obtain server configuration information that indicates the storage device requirements of the rack and/or servers in the rack from admin device 105 (e.g., laptop computer, tablet computer, smartphone, etc.) through network interface 110 (e.g., local area network, wide area network, the Internet, etc.). The management controllers can use intelligent platform management interface (IPMI) or Redfish application program interface (API) to remote control status light. The management controller is configured to communicate with a light controller. Inter-Integrated circuit/system management bus interface (I2C/SMbus) can be used to direct the control of light controller by the management controller.

Now turning to the operation of rack system 100, the operation of rack system 100 will be described primarily with respect to server 145. However, this is solely for ease of illustration, not by way of limitation. The present disclosure contemplates that the same or similar operations can be performed on servers 115 or 175, unless otherwise indicated below.

In operation, server 145 can be configured such that controller 165 can cause indicator device 170 to be activated to indicate that PSU fan 155 needs to be re-installed. In some implementations, the controller 165 can make this determination based on the information from the PSU storage device 160. The PSU Storage device 160 can be configured to store PSU fan configuration information that includes at least a current fan direction information. (i.e., the correct direction of airflow for the PSU). In other words, the fan direction information indicates the installation position of the PSU fan. For example, the PSU fan can be installed so the direction of airflow is towards the inside of the server (inward), as illustrated in the server 115, or toward the outside of the server (outward), as illustrated in server 145. The fan directions should not be limited to the described directions, and can include other directions that are not described above.

As noted above, the fan direction may not be marked on the PSU fan or the PSU. Thus, when an assembly-technician installs the PSU into the server, he/she may not be able to determine the correct direction of airflow. Therefore, there is a possibility that the assembly-technician may install the PSU in a wrong direction. Or alternatively in the case where the assembly technician needs to choose between different PSUs with different fan directions, the assembly technician may choose the wrong PSU. If the fan (or PSU) is not properly installed, this may affect the cooling efficiency of the server, and can cause the server to become overheated. Thus, as noted above, to avoid the overheating problem, indicator device 170, such as a fault light, can be provided in server 145 to notify the assembly-technician that the PSU fan needs to be re-installed or a different PSU needs to be installed.

For example, as shown in FIG. 1, when indicator device 170 is implemented as a fault light, it can be illuminated to indicate that the PSU fan 155 needs to be re-installed in server 145. Alternatively, it can indicate that a PSU with a different airflow direction fan needs to be installed. The light from such fault lights will attract the assembly-technician's attention, and it enables the assembly-technician to easily detect the fan direction problem. Other devices such as a sound device can work as the indication device to attract the attention. Once the assembly-technician re-installs the PSU fan to a correct/recommended direction, the fault light will get turned off to show that the re-installment is completed. The controller will log the event indicating that the fault light went active when detecting the error and became inactive after the re-installment has been completed. The controller can keep the event history of the related components for managing the PSU fan.

In some embodiments, the server can be de-activated if the PSU or PSU fan are not replaced correctly within the critical period of time. If the PSU fan is not working properly for a critical time period, it will cause overheating of the server. In order to prevent overheating of the server that can lead to data loss, the server can be de-activated (turned off) if the fault light has been active for more than the threshold amount of time. The threshold amount of time can be pre-defined based on the server and PSU configuration.

In embodiments utilizing fault lights, the fault lights can be light emitting diodes (LED) or any other type of illumination devices. To attract attention, the fault lights can be configured to operate in a flashing or blinking manner, or be shown in different colors. The methods of lighting described above are not exhaustive and there may be other ways for operating such fault lights.

The controller 165 is configured to obtain the PSU fan configuration information from the storage device of PSU 160. The fan configuration information can be sent to the controller 165 through the PMBUS command from the storage device 160. The fan configuration information includes the current PSU fan direction configuration information

The system controller 165 is further configured to use the received current airflow direction information to make a determination whether the current PSU fan airflow direction is the correct direction. For example, the controller stores the pre-defined (recommended/correct) airflow direction of the PSU fan in the controller. The controller can compare whether the pre-defined airflow direction is consistent with the received current airflow direction. If the airflow direction of the PSU fan is not consistent with the received fan direction, it indicates that the PSU fan is installed improperly, and a notification is generated to indicate that the PSU fan needs to be re-installed or replaced. On the other hand, if the airflow direction of the PSU fan of PSU is consistent with the received fan direction, it indicates that the PSU fan is installed properly, and a notification is not generated. The notification will attract the assembly-technician that the re-installment is required. Once the re-installment of the PSU fan or the PSU is completed, the notification (e.g. false light) will be turned off to show that the re-installment is properly performed. If the re-installment is not performed within the critical period of time, then the server can be de-activated to prevent the overheating. A counter/timer can be initiated when the false light gets activated and determine when to shut off the server. The controller may initiate a data backup process to prevent data loss before the server gets turned off.

The PSU 150 is further configured to receive information about an airflow direction of the server fan 158. The server fan airflow direction is stored in a memory device in the server 115 and sent to the controller 135 for a determination. The controller 135 compares the server fan airflow information with the received PSU fan information from the storage device 160. The controller can make a determination whether the current PSU fan airflow direction is consistent with the server fan airflow direction. When the PSU airflow information is not consistent with the server fan direction as illustrated in server 145 or server 175, the fault light 170 or 197 will be illuminated to indicate that the PSU fan airflow is not correct, and thus, it needs to be re-installed.

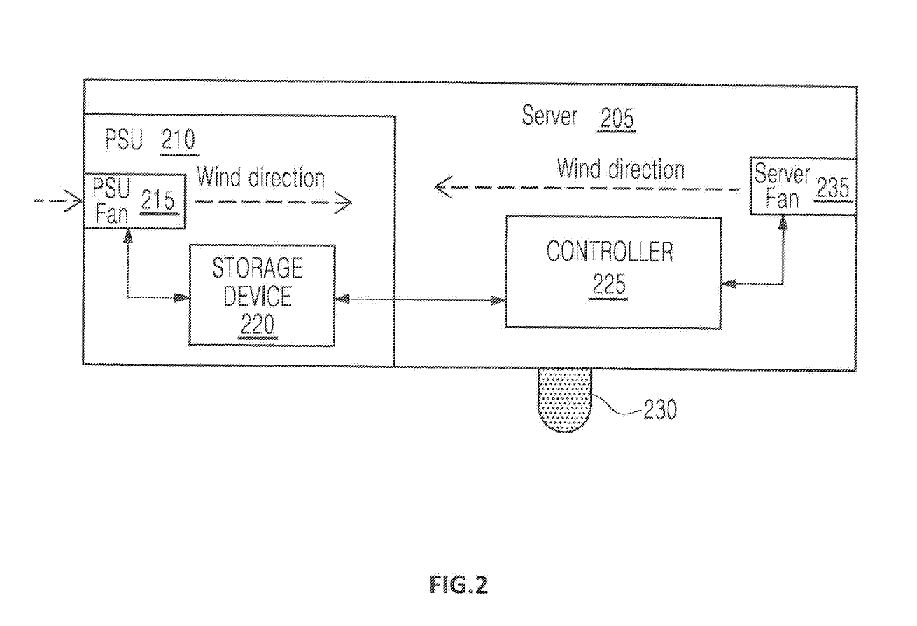

Now turning to FIG. 2, there is shown an example server 205 showing a condition in which an indication device 230 is active. The server 205 can include power supply unit 210, management controller 225, and server fan 235. The PSU can include PSU fan 215 and memory device 220. The memory device 220 can be a register that saves the PSU fan configuration information. The PSU fan configuration can include the PSU fan airflow direction information, such as which direction the PSU fan is installed (i.e., which direction the fan blades is facing). Such information can be written in the memory device when the PSU is built. This information can be sent to the controller 225 via SMBUS (system management bus).

This information is compared with the pre-defined PSU fan information stored in the controller 225. The pre-defined PSU information indicates the correct/recommended way that the PSU or the PSU fan should be installed. The pre-defined PSU information is based on the configuration of the server and the PSU. Each configuration can be different, and therefore, the pre-defined direction can be different based on different configurations of the servers.

In FIG. 2, the PSU fan 210 blows the air toward the center of the server. According to the PSU configuration in FIG. 2, this is the incorrect direction. Thus, based on this configuration, the controller will determine that the pre-defined airflow direction is opposite from the current airflow direction. Thus, the controller will conclude that the PSU fan is installed incorrectly, the fault LED light 230 will light up as indicated, and a notification will be generated. Once the re-installment of the PSU fan or the PSU is completed, the notification (e.g. false light) will be turned off to show that the re-installment is properly performed. Determining the correct direction of the PSU fan 215 relative to the server 205 and the server fan 235 is critical. In particular, server 205 would typically use a significant amount of power to function and the PSU 210 would need to provide such power needed by the server 205 to function. The result is that the use of power in the server 205 generates heat. Further, as the PSU 210 provides the power for the server 205, this causes the PSU 210 to also generate a significant amount of heat. Thus, the PSU fan 215 must operate cooperatively with the server fan 235 to ensure that the temperature in the server 205 is maintained in an operable range. Further, as the ventilation windows are often located on the side wall(s) of the PSU, the PSU fan direction is important to efficiently cool the PSU.

In some examples, server fan 235 is integrated into the server. The server fan 235 can circulate the air in the server 205, and dissipate the heat generated by the server's functioning. Often, the heat is more concentrated inside the server 205, as more heat producing parts are integrated into the center of the server 205 and/or the lack of ventilation windows. Thus, it is important to blow the fan air in a consistent direction in order to provide sufficient airflow to cool the components in the server 205.

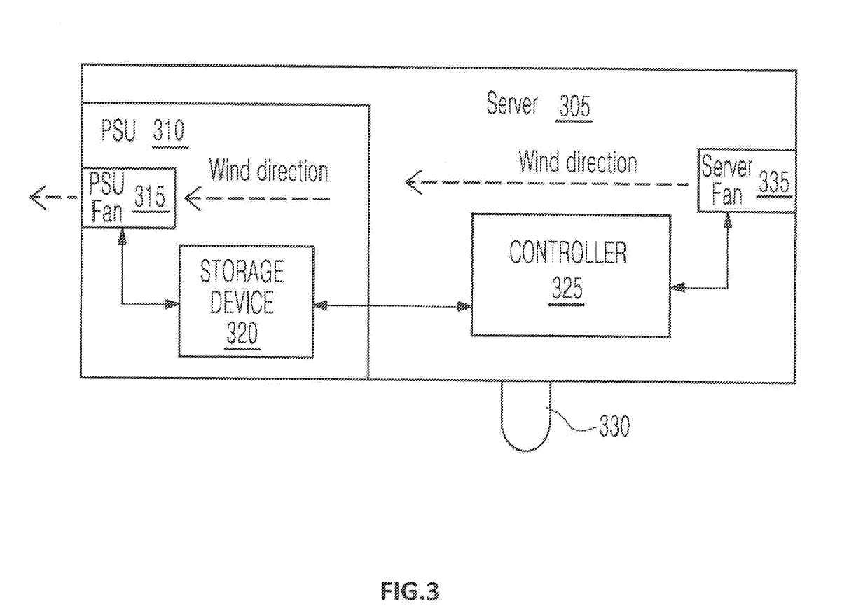

As illustrated in FIG. 2, the airflow direction of the PSU fan 215 faces the center of the server, and the airflow direction of the server fan 235 faces the center of the server 205. According to the fan configuration information, the PSU fan direction is incorrect because the airflow directions are inconsistent. To make a determination that the PSU fan direction is incorrect, the controller 225 will receive the airflow direction of the server fan 235 from the memory device in the server 205. For example, the server fan can blow the air in at least two directions: one towards the middle of the server and one towards the end/side of the server. Each direction can be assigned different value to indicate that these two directions are different. The controller 225 will further obtain the current PSU airflow fan direction from the storage device 220 in the PSU 210. The controller will compare the current server fan direction and the current PSU fan direction, and make a determination whether the current PSU fan direction is consistent with the server fan direction. As illustrated in FIG. 2, the current PSU fan direction is not consistent with the current server fan direction. Thus, the indication device 230 will be activated. The light on the indication device 230 will attract the assembly-technician that the re-installment is required. This can enable early detection of possible over-temperature issues on the server and the PSU. Now turning to FIG. 3, there is shown an example server 305 showing a condition in which an indicator device is activated in accordance with the various embodiments. The server 305 can include PSU 310, controller 325, and server fan 335. The PSU 310 can include PSU fan 315 and memory device 320. These components may be configured and arranged substantially similar to the components in FIG. 2. The memory device 320 receives the fan information from the PSU fan 315. The fan information includes at least a fan airflow direction such as the current fan wind (e.g. airflow) direction. As illustrated in FIGS. 2 and 3, the PSU fan can blow its air in at least two directions: one toward the center of the server 205 as illustrated in FIG. 2 and one toward the end/side of the server 305 as illustrated in FIG. 3. In some embodiments, the fan direction towards the center of the server can be assigned a first value and the fan direction towards the end/side of the server can be assigned a second value. The first value and the second value may be different. There can be various other airflow directions such as parallel/side-way directions, and the direction information described above are not intended to limit equivalent directions.

In some examples, the system controller 325 is configured to obtain the fan configuration information from the PSU 310. The memory device 320 of the PSU 310 is configured to store the current fan airflow direction, and send the current airflow direction information to the controller 325. The controller 325 is configured to receive the current server fan airflow direction from the memory device in the server 305. The controller 325 further obtains the PSU fan airflow direction from the storage device 320. The PSU stores the PSU fan information in the storage device 320 and the PSU fan information is sent to the controller 325 through the controller firmware. The system controller can then determine whether the current airflow direction of the PSU fan 315 is consistent with the pre-defined PSU fan direction stored in the controller. As illustrated in FIG. 3, the server fan direction and the PSU fan direction are consistent. The indication device 330 will remain inactive.

In connection with the FIG. 2 and FIG. 3, the PSU can be re-installed properly by a technician as a result of the activation of the indication device. As described above, when the indication device become active (toggled), the timer/counter may be started to count the time to make sure that the server is not operated for more than the threshold amount of time. The overheating of the server caused from the incorrect installation of the PSU or the PSU fan may cause a data loss if the server is being operated for more than a critical period of time. This critical time can be determined based on the configuration of the server and the PSU, and can be stored in the controller. Before it gets to the threshold amount of time, then a data back-up process can be initiated to prevent the data loss. Even if the server gets turned off, the indication device may still be flashing to attract the technician that the PSU reinstallation is still necessary. In some cases, the indication device may not reflect the correction immediately, as the replacement process can be performed quickly. Since in some cases the reflection process is not performed as quickly as the replacement process, it may appear that the replacement process hasn't been performed yet.

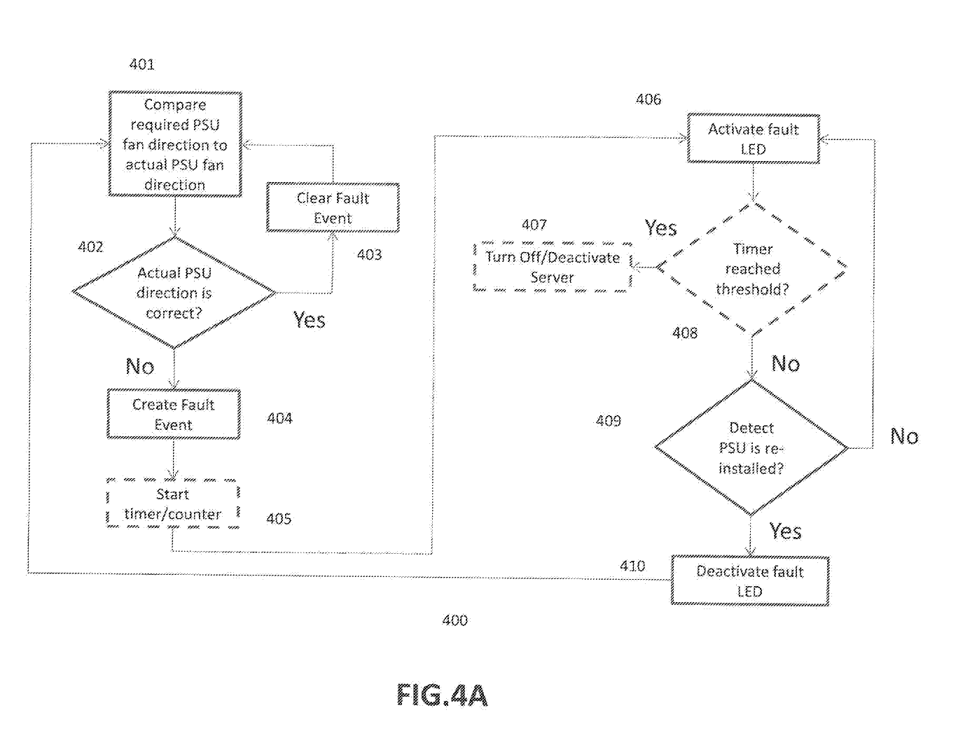

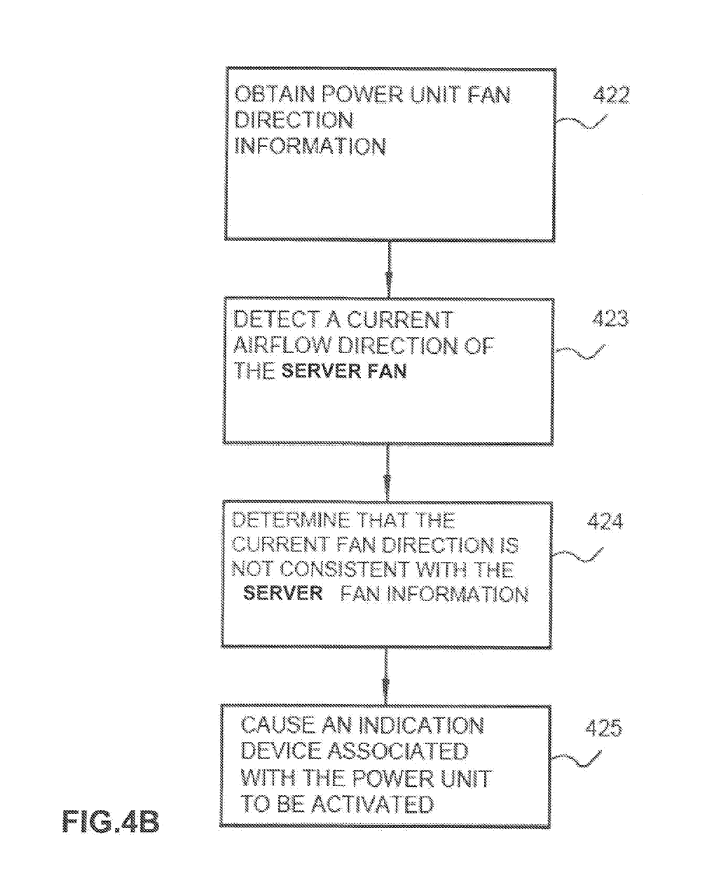

FIGS. 4A and 4B are flow diagrams for managing the PSU fan in accordance with the various embodiments. In FIG. 4A, the example process 400 shows an example process of managing the PSU fan. At 401, the controller will compare the actual (current) airflow direction of the PSU with the required (pre-defined) airflow direction. At step 402, upon determining that the actual PSU direction is not correct, the controller will create a fault event. At 404, the fault event will generate a notification indicating that the PSU fan needs to be re-installed. At 403, upon determining that the actual PSU direction is correct, the controller will clear the fault event. When the fault event is generated, the timer/counter will set the timer to measure the time to make sure that the measured time does not go over the critical amount of time pre-defined by the controller. At step 406, the indication device will be activated to attract the technician's attention. The indication device (fault LED) will be on until determining that the PSU is installed with the right direction as step 409. The fault LED will remain on if the PSU is not installed properly. At step 408, the timer will determine whether the timer reached the threshold amount of time. At step 407, upon determining that it reached the threshold amount of time, the server will become inactivated and turned off to prevent overheating. At step 410, the fault LED will be inactivated upon determining that the PSU is re-installed.

In FIG. 4B, at step 422, a system controller can obtain the fan configuration information from the memory device of the PSU. For example, the memory device in the PSU includes configuration information related to a fan airflow direction, and sends it to the system controller in response to receiving the PMBUS command from the system controller. The fan airflow information includes the fan airflow requirements such as the current fan position or the installment direction. The current fan position is determined by the direction the fan blades. At step 423, the system controller can detect the sever fan direction from a memory device in the server. At step 424, the system controller can determine if the PSU fan is in the correct position. For example, the controller will compare the PSU fan information from the PSU memory device and the server fan information. If the PSU fan air blows in the same direction as the server fan air, the PSU fan is properly installed. If the PSU air blows in the inconsistent direction as the server fan, the PSU fan is not properly installed. The directions or the installment configuration information described above are not intended to limit any equivalent directions or the installment configurations, and there may be alternative directions or installment configurations.

At step 425, an indication device will become active (e.g. lights up) if the server fan airflow direction is not consistent with the PSU fan airflow direction. On the other hand, if the server fan airflow direction is consistent with the PSU fan airflow direction, then the indication device will remain inactive.

In some embodiments, an indication device (e.g. the fault LED) is activated, if the airflow direction (i.e. fan direction) is not consistent with the received fan configuration. The indication device can be a light associated with the PSU that indicates the status of the PSU fan. The activated indication device can give a warning to the assembly-technician that the associated PSU needs an attention or re-installment. The light is visible from the outside of the server 205 in order for the assembly-technician to identify which PSU fan is improperly installed. Each PSU may be associated with at least one fault LED. The fault LED can be lighted up in various ways, such as blinking or flashing manner, or lighting in different colors.

On the other hand, if the airflow direction is consistent with the received fan configuration, then the fault LED will not light up. By notifying the assembly-technician when detecting the difference in fan direction, the assembly-technician can re-install the PSU fan before the temperature of the server reaches to the threshold level, and therefore, can save the server failure due to overheating.

### Example System Architecture

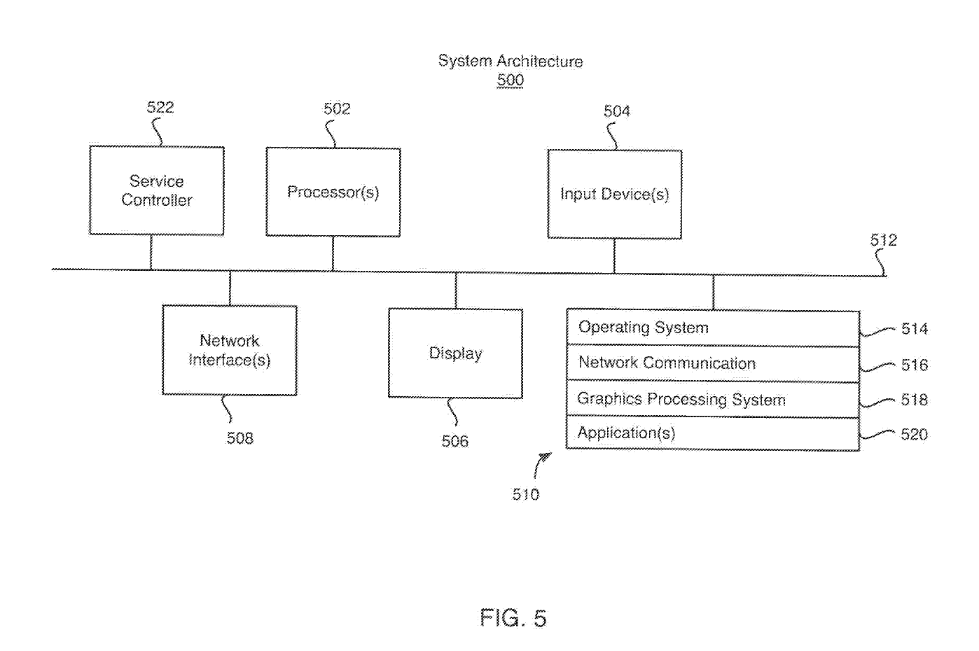

FIG. 5 is a block diagram of example system architecture 500 implementing the features and processes of FIGS. 1-4. The architecture 500 can be implemented on any electronic device that runs software applications derived from compiled instructions, including without limitation personal computers, servers, smart phones, media players, electronic tablets, game consoles, email devices, etc. In some implementations, the architecture 500 can include one or more processors 502, one or more input devices 504, one or more display devices 506, one or more network interfaces 508 and one or more computer-readable mediums 510. Each of these components can be coupled by bus 512.

Display device 506 can be any known display technology, including but not limited to display devices using Liquid Crystal Display (LCD) or Light Emitting Diode (LED) technology. Processor(s) 502 can use any known processor technology, including but are not limited to graphics processors and multi-core processors. Input device 504 can be any known input device technology, including but not limited to a keyboard (including a virtual keyboard), mouse, track ball, and touch-sensitive pad or display. Bus 512 can be any known internal or external bus technology, including but not limited to ISA, EISA, PCI, PCI Express, NuBus, USB, Serial ATA or FireWire.

Computer-readable medium 510 can be any medium that participates in providing instructions to processor(s) 502 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Computer-readable medium 510 can include various instructions 514 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 504; sending output to display device 506; keeping track of files and directories on computer-readable medium 510; controlling peripheral devices (e.g., disk drives, printers, etc.) which can be controlled directly or through an I/O controller; and managing traffic on bus 512. Network communications instructions 516 can establish and maintain network connections (e.g., software for implementing communication protocols, such as TCP/IP, HTTP, Ethernet, etc.).

A graphics processing system 518 can include instructions that provide graphics and image processing capabilities. Application(s) 520 can be an application that uses or implements the processes described in reference to FIGS. 1-4. The processes can also be implemented in operating system 514.

Management controller (e.g. service controller) 522 can be a controller that operates independently of processor(s) and/or operating system 514. In some implementations, management controller can be powered and operational before processor(s) 502 are powered on and operating system 514 is loaded into processor(s) 502. For example, management controller can provide for pre-OS management of the computing device through a dedicated network interface or other input device. For example, management controller can be a baseboard management controller (BMC) that monitors storage device lights (e.g., status LED lights) and performs low level management of the storage devices, and/or provides remote management capabilities through an intelligent platform management interface (IPMI), keyboard, video, and mouse (KVM) redirection, serial over LAN (SOL), and/or other interfaces. Management controller can be implement the processes described with reference to FIGS. 1-4 above.

Light controller can be a light-emitting diode (LED) controller. Light controller can be a controller that controls the lights associated with the memory device, and provides remote management capabilities through the Inter-Integrated circuit/system management bus (I2C/SMbus) or SGPIO controller interface. The light controller can be a serial general purpose input/output (SGPIO) LED controller. In some examples, the light controllers can be located in the backplane of the server. For example, the SGPIO LED controller is configured to control backplane storage device status lights. The SGPIO LED controller can be managed by at least two interfaces such as Inter-Integrated circuit/system management bus (I2C/SMbus) or SGPIO controller interface.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

For clarity of explanation, the illustrative system embodiment is presented as including individual functional blocks including functional blocks labeled as a “processor” or processor 502. The functions these blocks represent may be provided through the use of either shared or dedicated hardware, including, but not limited to, hardware capable of executing software and hardware, such as a processor 502, that is purpose-built to operate as an equivalent to software executing on a general purpose processor. For example the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) for storing software performing the operations described below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited tangible computer-readable storage devices. Such logical operations can be implemented as modules configured to control the processor to perform particular functions according to the programming of the module.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed examples can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Any of the features disclosed with respect to any particular examples can be mixed and matched with any other examples or any other discussion of features. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A method comprising:
obtaining, by a controller, a current airflow direction of a power unit fan from a memory device in a power supply unit (PSU);
retrieving, by the controller, a pre-defined airflow direction for the power unit fan;
determining, by the controller, that the current airflow direction of the power unit fan is inconsistent with the pre-defined airflow direction of the power unit fan to yield a determination; and
causing, by the controller, an indication device associated with the power unit fan to be toggled in response to the determining.

2. The method of claim 1, further comprising:
generating, by the controller, a notification based at least in part on the determination, wherein the notification indicates that the power unit fan needs to be re-installed.

3. The method of claim 1, wherein the indication device is a fault light emitting diode (LED).

4. The method of claim 1, further comprising:
obtaining, by the controller, a current airflow direction of a server fan;
determining, by the controller, that the current airflow direction of the power unit fan is inconsistent with the current fan airflow direction of the server fan; and
causing, by the controller, the indication device associated with the power unit fan to be toggled.

5. The method of claim 1, further comprising:
initiating a counter associated with the server;
determining that the indication device is active for more than a threadshold amount of time; and
de-activating the server.

6. The method of claim 1, wherein the controller is a baseboard management controller (BMC).

7. The method of claim 1, further comprising:
determining that the current airflow direction of the power unit fan is consistent with the pre-defined airflow direction of the power unit fan; and
de-activate the indication device.

8. The method of claim 1, further comprising:
receiving, from the memory device of the power unit, the current airflow direction of the power unit fan through a SMBUS.

9. The method of claim 1, further comprising:
upon determining that the indication device is active for more than a pre-defined period of time, initiating a data backup process.

10. A server system comprising:
a power unit comprising:
a fan;
a memory unit, the memory unit configured to store fan information, the fan information comprising airflow direction information; and
a management controller, the management controller configured to:
receive the fan information to yield received fan information;
retrieve a pre-defined airflow direction of the fan;
determine that the airflow direction of the fan is inconsistent with the retrieved fan information to yield a determination; and
cause an indication device associated with the power unit to be toggled.

11. The server system of claim 10, wherein the management controller further configured to generate a notification based at least in part on the determination, wherein the notification indicates that the power unit fan needs to be re-installed.

12. The server system of claim 10, wherein the indication device is a fault light emitting diode (LED).

13. The server system of claim 10, wherein the management controller further configured to:
initiating a counter associated with the server;
determining that the indication device is active for more than a threadshold amount of time; and
de-activating the server.

14. The server system of claim 10, wherein the management controller further configured to:
determine, by the management controller, that the current airflow direction of the fan is consistent with the received fan information to clear an event, the event indicating that the power unit fan needs to be re-installed.

15. The server system of claim 10, wherein the management controller is a baseboard management controller (BMC).

16. The server system of claim 10, further comprising:
a server fan; and
a server memory unit, wherein the server memory unit is configured to:
send the server fan information to the management controller;
receive the server fan information from the server memory unit, the server fan information including at least a current server fan airflow direction; and
determine that the current server fan airflow direction is inconsistent with the airflow direction of the power unit fan; and
in response to determining that the server fan airflow direction is inconsistent with the airflow direction of the power unit fan, generate the notification indicating that the airflow direction of the power unit fan is incorrect.

17. The server system of claim 10, wherein the management controller further configured to:
determining that the current airflow direction of the power unit fan is consistent with the pre-defined airflow direction of the power unit fan; and
de-activate the indication device.

18. A non-transitory computer-readable medium storing instructions which, when executed by a system controller, cause the system controller to perform operations comprising:
receiving, at the system controller of a computing device, a power supply unit (PSU) fan configuration, the PSU fan configuration including at least a current PSU fan direction;
retrieving, at the system controller, a pre-defined PSU fan direction;
determining, at the system controller, the pre-defined PSU fan direction is inconsistent with the current PSU fan direction to yield a determination; and
causing an indication device to be activated in response to the determining.

19. The non-transitory computer-readable medium of claim 18, wherein the current PSU fan direction being stored in a memory device of a power supply unit and being sent to the system controller.

20. The non-transitory computer-readable medium of claim 18, wherein the instructions, further causes the system controller to perform operations, further comprising:
initiating a counter associated with the server;
determining that the indication device is active for more than a pre-defined period of time;
performing a data back-up process in the server;
determining that the indication device is active for more than a threshold amount of time; and
de-activating the server.
